(19) United States
(12) Patent Application Publication
(10) Pub. No.: US 2025/0360705 A1
(43) Pub. Date: Nov. 27, 2025

(54) METHOD FOR OPERATING A PRINTING MACHINE FOR FLEXOGRAPHIC PRINTING

(71) Applicant: Heidelberger Druckmaschinen AG, Heidelberg (DE)

(72) Inventor: Werner Schwab, Bechtsrieth (DE)

(21) Appl. No.: 19/214,349

(22) Filed: May 21, 2025

(30) Foreign Application Priority Data
May 22, 2024 (DE) 10 2024 114 239.1

(51) Int. Cl. B41F 5/24; B41F 5/10; B41F 13/004; B41F 13/18

(52) U.S. Cl. CPC B41F 5/24; B41F 5/10; B41F 13/0045; B41F 13/18; B41P 2200/12; B41P 2213/734; B41P 2213/80

(57) ABSTRACT

A method for operating a printing machine for flexographic printing, wherein a web of printing stock is unwound, transported and thereby guided through at least two double printing units of the printing machine. Each of the double printing units has at least one impression cylinder and in each case two printing cylinders for flexographic printing. The impression cylinders are each driven in rotation by a separate motor and the printing cylinders are each driven in rotation by a separate motor. A computer of the printing machine calculates at least two virtual drive axes and the computer controls the motors in each case using one of the virtual drive axes. The method is particularly suitable for high-production and flexible processing in industrially operated, web-processing flexographic printing machines for packaging printing.

### CROSS-REFERENCE TO RELATED APPLICATION

This application claims the priority, under 35 U.S.C. § 119, of German Patent Application DE 10 2024 114 239.1, filed May 22, 2024; the prior application is herewith incorporated by reference in its entirety.

### FIELD AND BACKGROUND OF THE INVENTION

The invention relates to a method of operating a printing press for flexographic printing wherein a web of printing stock is unwound and transported through at least two double printing units of the printing machine. Each of the double printing units has at least one impression cylinder and two printing cylinders for flexographic printing. In addition to flexographic printing units, such a printing press can also comprise additional gravure printing units.

The technical field of the invention is the graphic arts industry and in particular in the field of operating a flexographic printing machine, i.e., a rotary printing machine for printing with flexographic printing formes on printing stock in web form. In particular, the invention lies in the field of providing open-loop or closed-loop control of the machine or its drives and/or actuators.

Modern web-processing printing machines for flexographic printing no longer work with a so-called king shaft, as disclosed, for example, in European Patent EP 0 464 309B1 and its counterpart U.S. Pat. No. 5,184,551. The king shaft connects the printing units in terms of drive technology, but have highly dynamic and precise servomotors for driving the printing units. Instead of a mechanical shaft or axis connecting the printing units, a virtual drive axis is used, which is implemented purely computationally and/or electronically.

There are already web-processing printing presses for flexographic printing that allow on-the-fly changes between two print jobs.

There are already web-processing printing presses for flexographic printing with a central impression cylinder and two or more printing cylinders arranged around it. Such machines are often very large and difficult to operate. In addition, the maximum number of colors that can be printed may be limited and it may not be possible to apply varnish.

German published patent application DE 10 2017 222 700 A1 and its counterpart U.S. Pat. No. 10,919,289 B2, which are commonly assigned, already disclose a printing machine for printing a printing stock web with a plurality of flexographic printing units arranged in series, wherein the flexographic printing units are arranged in a plane accessible to the machine operator, wherein always two flexographic printing units of the plurality of flexographic printing units together form a double printing station, and wherein the two flexographic printing units of a respective double printing station have a common impression cylinder.

Manufacturers of graphic products—for example, industrial print shops with a prepress, actual printing, and post-press department—have a constant desire to reduce or even eliminate downtimes of their web-processing presses. There is also a desire for cost-effective and compact printing presses. These should also have short web paths and thus generate little so-called start-up waste. Finally, they should also be flexible enough to be used for a wide variety of print jobs. In general, there is also a desire to improve product quality while maintaining or even increasing production speed.

### SUMMARY OF THE INVENTION

The present invention therefore addresses the problem of creating an improvement over the prior art which, in particular, enables a flexographic printing press to be operated in a highly productive and flexible manner.

With the above and other objects in view there is provided, in accordance with the invention, a method for operating a printing machine for flexographic printing. The printing machine has at least two double printing units, each including at least one impression cylinder and two printing cylinders for flexographic printing. The method comprises:
unwinding a web of printing stock, transporting and guiding the web through at least two double printing units of the printing machine;
driving each of the impression cylinders in rotation by a separate motor, and driving each of the printing cylinders in rotation by a separate motor;
and calculating by a computer of the printing machine at least two virtual drive axes, and controlling the motors by the computer in each case using one of the virtual drive axes.

In other words, in the method according to the invention for operating a printing press for flexographic printing a web of printing stock is unwound, transported and thereby guided through at least two double printing units of the printing press, and wherein the double printing units each comprise at least one impression cylinder and two printing cylinders for flexographic printing. In the novel method, the impression cylinders are each driven in rotation by a separate motor and the printing cylinders are each driven in rotation by a separate motor, and a computer of the printing press calculates at least two virtual drive axes and the computer controls the motors in each case using one of the virtual drive axes.

The invention makes it possible to operate a flexographic printing machine in a highly productive and flexible manner. The invention is particularly suitable, for example, in industrially operated, web-processing flexographic printing machines for packaging printing.

One advantage of the invention is that printing can be carried out simultaneously in a double printing unit (in one partial printing unit) and set-up can be carried out simultaneously (in the other partial printing unit) or printing can be carried out with both partial printing units, which makes the printing machine very flexible. A significant advantage of the invention is that the printing ink can also be set up with the double printing unit. The latter saves a lot of downtime and therefore increases productivity. Depending on how the printer wants to use the double printing units, they can choose between short web paths, which are made possible by the intermediate drying in the double printing unit, or fast job changes. It is also easy to switch from front-side to rear-side printing by selecting a different web path and simply reversing the direction of rotation of the rotary axes, i.e., from clockwise to counterclockwise or vice versa. Another advantage is that different formats can be printed simultaneously. The different formats are different, for example, if the prints have different lengths in the direction of web travel or if there are different printing cylinder circumferences. Finally, it is advantageous that partial printing units can be operated in the opposite direction of rotation (compared to other partial printing units of the printing press), e.g., “backwards” instead of “forwards” or counterclockwise instead of clockwise. This makes it possible, for example, to print the front and rear sides of a web in a single pass.

According to the invention, virtual drive axes are used. The virtual drive axes are computer-generated, e.g., based on the principle of a very precisely rotating (mathematical) vector, and are provided for controlling the corresponding rotary drives for cylinders or rollers of the printing press, preferably electric servomotors. Between a virtual axis and the corresponding real axis of a servo motor, there can be a so-called electronic gear and/or a real gear, which effects a transmission from the virtual to the real axis.

The virtual drive axes can be web transport axes or format axes. A web transport axis is used to control separate drives of the impression cylinders and/or driven cylinders or rollers that convey the web, e.g., also chill rollers or guide rollers. A format axis is used to control separate drives of the printing cylinders and/or anilox rollers. Since the printing cylinders (or their sleeves and/or printing plates) can have different formats depending on the print job, a format axis is preferably adapted to the current format of the cylinder to be printed, i.e., the respective angular speed is adapted. A web transport axis can be calculated and provided as a master axis and a format axis as a related slave axis. One advantage of coupling by means of virtual axes is that any real axes (e.g., servo motor axes) can also be connected during operation of the printing press, for example the axes of the anilox rollers can be coupled to the web transport axis, in particular via electronic gears.

Preferred developments of the invention (in short: developments) are described below. Unless a specific combination is not technically feasible, the various developments can also be combined with one another.

### Virtual Drive Axes

In accordance with an added feature of the invention,
the motors of the impression cylinders are controlled using a common virtual web transport axis. Preferably, a single web transport axis is calculated and provided, e.g., as a rotating vector.
the motors of the printing cylinders are each controlled using separate virtual format axes. Preferably, several format axes are calculated and provided, e.g., as rotating vectors, especially if different formats, e.g., on different sides or longitudinal strips of the web, are printed simultaneously. Printing cylinders, or their rotary drives, of different double printing units can be controlled via different virtual format axes. For a given print job, a printing press can be controlled via several virtual drive axes, e.g., via a virtual web transport axis and via one, two, three or more virtual format axes.
the motors of the printing cylinders of respective partial printing units of the double printing units are actuated using two virtual format axes. It may be provided that, in the double printing units, a respective partial printing unit is assigned to a first virtual drive axis and that the respective other partial printing units of the double printing units are assigned to a second virtual drive axis. This solution is advantageous in particular when performing a flying changeover between two directly following print jobs.
the motors of the printing cylinders are actuated using a common virtual format axis.
at least one web tension roller is used in the printing press, wherein the web tension roller is driven in rotation by a separate motor.
the motor of the web tension roller is controlled using the common virtual web transport axis.
the motor of at least one web tension roller, using the virtual web transport axis, is positively or negatively superimposed in speed with the position or deflection of a dancer roller or a web measuring roller (or a value derived therefrom), so that a desired, e.g., predetermined web tension results.
the control takes place using the common virtual path transport axis with a path angular velocity.
the respective control takes place using the respective virtual format axis with a respective format angular velocity.
the web angular speed and at least one of the format angular speeds match when printing a print job. It is also possible for the two angular speeds to deviate from each other, e.g., only temporarily and e.g., if a change in web length (shrinkage or stretching) is to be compensated for.
when printing a different print job, the web angular speed and at least one of the format angular speeds differ by a factor not equal to 1. This enables a preferably slight compression or stretching of the printed image.
when printing a different print job, the web angular speed and at least one of the format angular speeds differ by a factor of −1. In this way, at least one partial printing unit of a double printing unit can be operated with the direction of rotation reversed and the partial printing unit can print on the rear side of the web; preferably both partial printing units.

### Switchover Between Front- and Rear-Side Printing

In accordance with an additional feature of the invention,
during a first print job, a first impression cylinder of a first double printing unit and a second impression cylinder of a second double printing unit rotate in the same direction.
the first impression cylinder is controlled using the common virtual web transport axis and the second impression cylinder is controlled using the common virtual web transport axis.
at least two or all double printing units print on the same side of the web during the first print job.
during a second print job, the first impression cylinder of the first double printing unit and the second impression cylinder of the second double printing unit rotate in opposite directions. In this way, a partial printing unit of a double printing unit can be operated with the direction of rotation reversed and the partial printing unit can print on the rear side of the web.
the first impression cylinder is controlled using the common virtual web transport axis and the second impression cylinder is controlled using the reverse common virtual web transport axis, e.g., using a so-called electronic transmission.
at least two or all double printing units print on opposite sides of the web during the second print job.
when changing from the first print job to the second print job, the web path is changed from a first double printing unit to a second double printing unit.
the web path during the first print job lies substantially over a horizontal area in which the axes of rotation of the impression cylinders are located.
the web path for the second print job is partially below a horizontal area in which the axes of rotation of the impression cylinders are located.
inactive virtual axes are changed during ongoing press production, e.g., accelerated or decelerated to a desired or specified angular speed.

### Changing Formats

In accordance with yet an additional feature of the invention,
a first double printing unit comprises a first printing cylinder and a second printing cylinder and a second double printing unit comprises a third printing cylinder and a fourth printing cylinder.
the first printing cylinder and the third printing cylinder have a first circumferential format.
the second printing cylinder and the fourth printing cylinder have a second circumferential format—different from the first circumferential format.
the circumferential formats are given by the outer circumference of the printing cylinders or by the outer circumference of sleeves on the printing cylinders that carry the print image(s).
at least one flexographic printing forme is arranged on the printing cylinders or on the sleeves in the circumferential direction.
at least one flexographic printing forme is arranged on the printing cylinders or on the sleeves in the transverse direction.
the first printing cylinder and the third printing cylinder rotate at a first angular speed during a first print job.
the first angular velocity is given by the first circumferential format.
during the first print job, the second printing cylinder and the fourth printing cylinder are disengaged from the respective impression cylinder.
during a second print job, the second printing cylinder and the fourth printing cylinder rotate at a second angular speed, which is different from the first angular speed.
the second angular velocity is given by the second circumferential format.
during the second print job, the first printing cylinder and the third printing cylinder are disengaged from the respective impression cylinder.
during the first print job the first printing cylinder and the third printing cylinder are controlled using the same virtual format axes or during the first print job the first printing cylinder and the fourth printing cylinder are controlled using the same virtual format axes.
during the first print job the first printing cylinder and the third printing cylinder are controlled using the same virtual format axis or during the first print job the first printing cylinder and the fourth printing cylinder are controlled using the same virtual format axis.
during the second print job the second printing cylinder and the fourth printing cylinder are controlled using the same virtual format axes or during the second print job the second printing cylinder and the third printing cylinder are controlled using the same virtual format axes.
during the second print job the second printing cylinder and the fourth printing cylinder are controlled using the same virtual format axis or during the second print job the second printing cylinder and the third printing cylinder are controlled using the same virtual format axis.
the printing cylinders are controlled using different virtual format axes for the first print job and the second print job.
a first print job is produced with rotating first printing cylinders and meanwhile a second print job is prepared with stationary second printing cylinders; the impression cylinders associated with the first and second printing cylinders rotate coupled to the virtual web transport axis and at a given time, e.g., at the end of the first print job, a change is made from the first to the second print job.

### Web Strip

In accordance with a further feature of the invention,
the web is printed on at least one side in at least two longitudinal strips parallel to each other. One longitudinal strip can, for example, be on DS and a second on OS (DS: drive side; OS: operating side).
print jobs with different formats are printed in the longitudinal strips.
print jobs with different longitudinal formats are printed in the longitudinal strips.
print jobs with different landscape formats are printed in the longitudinal strips.

### Number of Impression Cylinders

A further development of the invention is distinguished in that
at least one double printing unit is provided and operated with only one impression cylinder.
at least one double pressure unit with two impression cylinders is provided and operated.
at least one dryer is provided and operated in the double printing unit.

### Single Printing Unit

In accordance with again an added feature of the invention, at least one single printing unit is provided and operated.

### Drying/Dryer

In accordance with another feature of the invention,
the web is dried.
at least one dryer is arranged and operated on the web path after each double printing unit and the web is dried after each double printing unit.
at least one dryer is arranged and operated on the web path in each double printing unit, e.g., on the impression cylinder or between two impression cylinders, and the web is dried in each double printing unit.
at least one dryer is arranged and operated on the web path in each double printing unit between two impression cylinders and the web is dried in each double printing unit.
the dryer may be a hot air dryer, a UV dryer, and/or an IR dryer.

### Series Design

In accordance with an added feature of the invention,
the double printing units are arranged in a horizontal row.
the double printing units are arranged in such a way that the axes of rotation of the impression cylinders lie in a horizontal area.
the double printing units are arranged in such a way that the axes of rotation of the impression cylinders lie in a horizontal plane.
the horizontal level is at operating height above the floor of a production facility.
four or more colors are printed and a corresponding number of double printing units are operated.
lacquer is applied and a lacquer unit is operated downstream of the double printing units for this purpose. The coating unit can be designed as a gravure printing unit.
one or more barrier layer(s) is/are applied in a so-called barrier unit, e.g., as lacquer layer(s), wherein the barrier unit is designed as a single or double printing unit.

### Flying Changeover and Set-Up

In accordance with yet an added feature of the invention,
there is a flying changeover between a first print job and an immediately following second print job. This enables uninterrupted production.
in the case of at least two double printing units, switching from one partial printing unit to the other partial printing unit or vice versa.
the changeover is carried out in the correct register. This avoids waste.
the changeover is carried out precisely. Waste is avoided by switching in such a way that the two print jobs or the corresponding print images come to rest on the web without any significant distance between them in the longitudinal direction.
switching takes place in such a way that substantially no waste is generated.
one partial printing unit is being set up while the other partial printing unit is printing.
at least one printing plate (printing forme) is changed during set-up.
at least one sleeve with at least one printing plate is changed during set-up.
the print image is changed during set-up.
the format is changed during setup.
the format length is changed during setup.
the format width is changed during setup.
at least one printing ink is changed during set-up.
the computer calculates a first virtual drive axis for the motors of the mating printing cylinders of double printing units, the computer calculates a second virtual drive axis for the motors of the format cylinders of the first partial printing units of the double printing units for a first print job and a third virtual drive axis for the motors of the format cylinders of second partial printing units of the double printing units for a directly following second print job, and a flying changeover from the first print job to the second print job is performed, changing from the second virtual drive axis to the third virtual drive axis. This solution is advantageous in particular for interruption-free and precise switching with the correct register between the respective partial printing units of the double printing units, because production runs without disruption and waste is reduced or avoided, in particular when the format changes between the two print jobs.
the computer calculates a first virtual drive axis for the motors of the mating pressure cylinders of double printing units, the computer calculates a second virtual drive axis for the motors of the format cylinders of the two partial printing units of the double printing units for a first and a directly following second print job and a flying changeover from the first print job to the second print job is performed, the second virtual axis being maintained. This solution is advantageous in particular for interruption-free and precise switching with the correct register between the respective partial printing units of the double printing units, because production runs without disruption and waste is reduced or avoided, in particular when the format does not change between the two print jobs and a punch-cutting tool, e.g. a rotary punch cutter or a flatbed punch cutter is provided downstream of the printing operation in the finishing train.

### Further Processing

In accordance with a further feature of the invention,
a finishing station is arranged downstream of the double printing units in the production direction.
the further processing station comprises a punch cutter with one punch cutting unit or several punch cutters each with one punch cutting unit or at least one double punch cutter with two punch cutting units.
the punching format is adjusted when the print format is changed.
the punching format is adapted by switching between punching units.
the punching format is adapted by changing punching tools on the fly.
the further processing station comprises at least one semi-rotary punch.
the semi-rotary punch comprises a punching cylinder with a circumference of length L1 and a punching tool of length L2 arranged on the punching cylinder, where L2<L1.
a punching cylinder of the semi-rotary punch is driven at an alternating angular speed—between a higher and a lower one—wherein the lower angular speed is used during punching.
the semi-rotary punch includes a web storage unit.
the further processing station comprises at least one sheet cutter for cross-cutting the web into sheets.

The invention also makes it possible to convert a double printing unit and thereby change from front-side printing to rear-side printing (or vice versa) and/or change the print format and/or change the print format in a longitudinal strip.

The technical features and combinations of features disclosed in the foregoing paragraphs represent technical and exemplary embodiments which may be integrated with one another in any feasible combination.]

### Alternative Solution

An alternative to the invention that might be considered is a technical solution which makes use of only one virtual drive axis instead of multiple virtual drive axes. This virtual drive axis preferably actuates the rotary drives/motors of the mating printing cylinders. Taking this virtual drive axis as a basis, the format cylinders are actuated via what are referred to as electronic transmissions, i.e. using a respective highly accurate conversion factor.

Other features which are considered as characteristic for the invention are set forth in the appended claims.

Although the invention is illustrated and described herein as embodied in a method for operating a printing machine for flexographic printing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic side view of a configuration with two double-printing units in a flexographic printing machine.

FIG. 2 is a similar view, with a configuration in which the back side is printed and then the front side.

FIG. 3 is a similar view of a similar configuration, wherein one of the two double printing units has two impression cylinders.

FIG. 4 is a schematic plan view of a web-processing flexographic printing press.

FIG. 5 is a similar view of an alternative embodiment of a web-fed flexographic printing press.

FIG. 6 is a schematic side view of a web-processing, industrial flexographic printing machine with a reel changer, a web feeding device, six double printing units with dryers, and a rewinder 47.

FIG. 7 is a side view of a double printing unit with a single impression cylinder and two partial printing units.

FIG. 8 is a side view of a double printing unit with two impression cylinders and two partial printing units, each with a (flexographic) printing cylinder and an anilox roller.

FIG. 9 is a schematic view of a printing machine, similar to FIG. 6, wherein here the printing machine has an additional single printing unit 15.

Corresponding features and elements are identified with the same reference signs throughout the figures.

In the figures, NoD refers to a so-called “non-stop deck,” i.e., a double printing unit without intermediate drying, in which either one or the other partial printing unit prints. In the figures, DoD refers to a so-called “double deck,” i.e., a double printing unit with (optional) intermediate drying, in which either one or the other partial printing unit prints (without intermediate drying) or in which both partial printing units print and are dried in between.

### DETAILED DESCRIPTION OF THE INVENTION

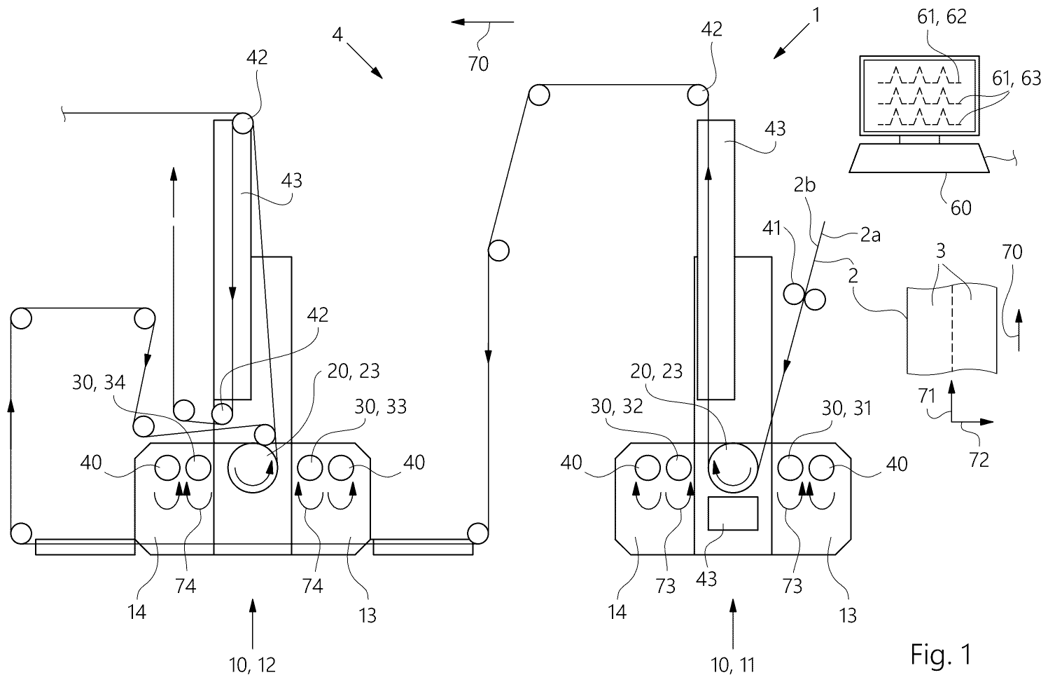

Referring now to the figures of the drawing in detail and first, in particular, to FIG. 1 thereof, there is shown a configuration of at least two double printing units 10 or 11 and 12 in a flexographic printing machine 1, which makes it possible to print both one side 2a (“front side”) of the web 2 and the other side 2b (“rear side”) of the web 2. For this purpose, the web path 4 at the second double printing unit 12 (shown on the left in the figure) is first guided horizontally under the double printing unit 12 or under its cylinders, then guided upwards and finally guided into the double printing unit 12 from above. It can be seen that the two impression cylinders 20 or 21 and 22 of the double printing units 10 shown rotate in opposite directions (correspondingly also the other cylinders of the partial printing units 13 and 14 of the double printing units 10). Turning bar arrangements with diagonally arranged turning bars are advantageously not required in this configuration. FIG. 1 also shows a computer 60, preferably a digital computer, e.g., an existing printing press computer or a separate control computer, which calculates the virtual drive axes 61 and provides them to the printing press 1 or the rotary drives 50. FIG. 1 also shows a detail of the web 2 in plan view with two longitudinal strips 3 and the web running direction 70.

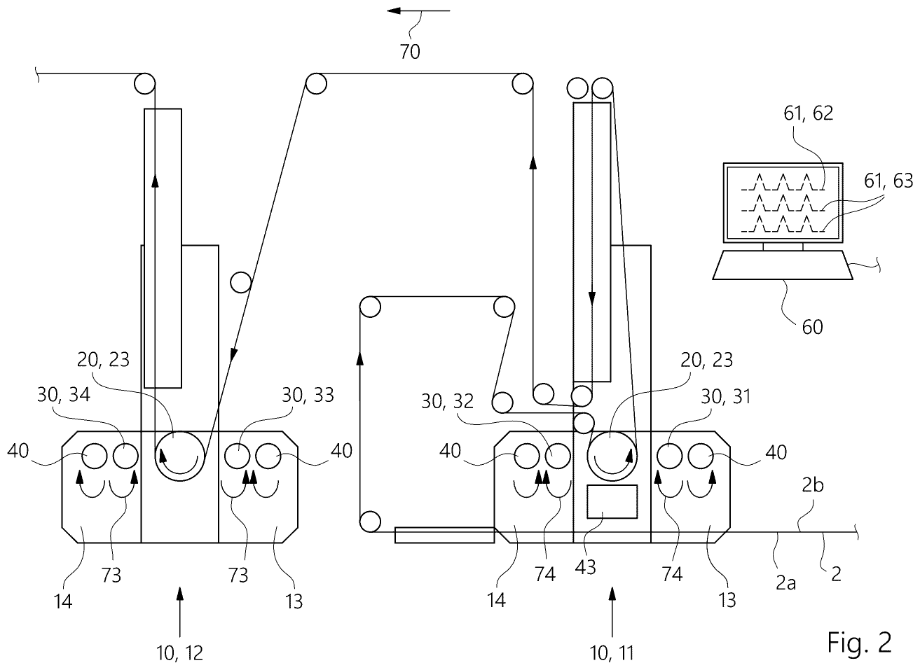

FIG. 2 shows a similar configuration to FIG. 1, wherein the rear side 2b is printed first and then the front side 2a. The two configurations shown can also be combined with each other (in one or the other order).

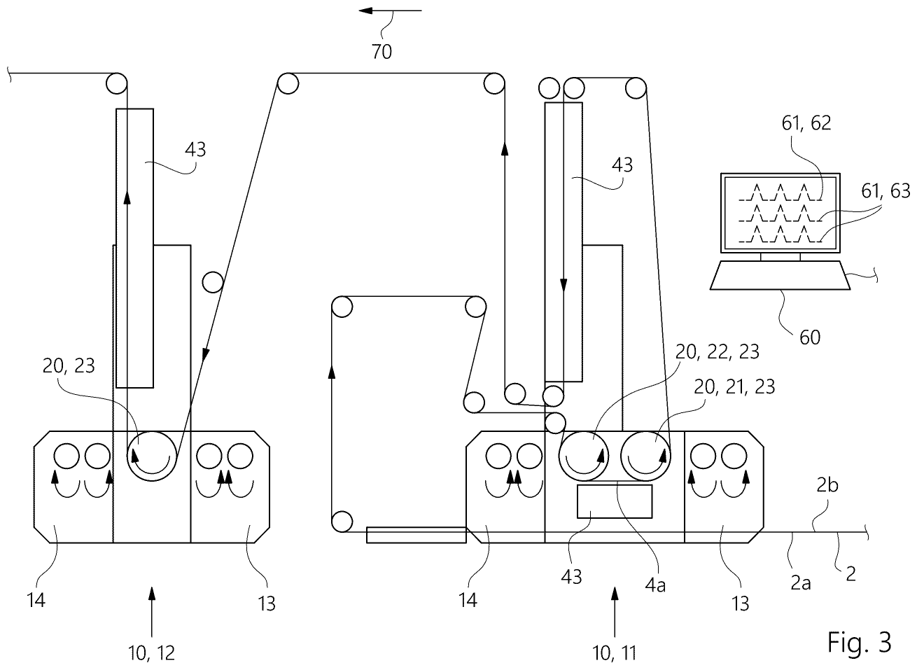

FIG. 3 also shows a similar configuration, wherein here one of the two double printing units 10 comprises two impression cylinders 20 or 21 and 22.

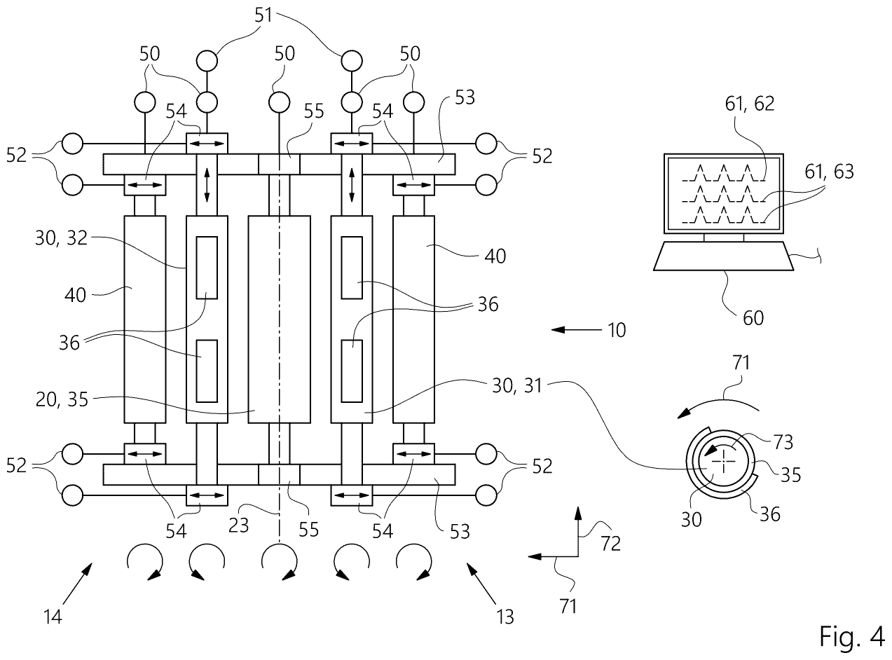

FIG. 4 shows the following: A web-processing flexographic printing press 1 (also referred to as a printing installation, system or machine) comprises at least one double printing unit 10 shown with side walls 53, a partial printing unit (A) 13, a partial printing unit (B) 14 and a common impression cylinder (GDZ) 20; also two printing cylinders (DZ) 30 and two anilox cylinders (RZ) 40. FIG. 4 also shows a computer 60, preferably a digital computer, e.g., an existing printing press computer or a separate control computer, which calculates the virtual drive axes 61 and provides them to the double printing unit 10 or the rotary drives 50. FIG. 4 also shows a sectional view through an exemplary printing cylinder (DZ) 30 with an (axially push-on) sleeve 35 and at least one printing plate 36, or printing forme 36 (mounted on the sleeve). The GDZ cylinder 20 is mounted in bearing blocks 55, the DZ cylinders 30 are mounted in adjustable bearing blocks 54 and the cylinders 40 are mounted in further adjustable bearing blocks 54. The adjustable bearing blocks 54 are adjustable in a direction 71 by means of positioning drives 52. The DZ cylinders 30 are also adjustable in axial direction 72 by means of positioning drives 51.

The following nomenclature is used for the drives in the double printing unit 10 with the two partial printing units A and B:
(A)Rot_DZ: Rotary drive 50 for the printing cylinder in partial printing unit A;
(A)Rot_RZ: Rotary drive 50 for the anilox cylinder in partial printing unit A;
Rot_GDZ: Rotary drive 50 for the common impression cylinder;
(A)Posi_Axial: Positioning drive 51 for page register in partial printing unit A;
(A)Posi_DZDS: Positioning drive 52 for the printing cylinder in partial printing unit A on the drive side;
(A)Posi_DZOS: Positioning drive 52 for the printing cylinder in partial printing unit A on the operating side;
(A)Posi_RZDS: Positioning drive 52 for the anilox cylinder in partial printing unit A on the drive side;
(A)Posi_RZOS: Positioning drive 52 for the anilox cylinder in partial printing unit A on the operating side;
Corresponding drives (B) . . . are provided for the partial printing unit B.

A first print job is running in partial printing unit A. At the same time, a second print job can be prepared in the partial printing unit B or the partial printing unit B can be serviced, e.g., a blade change can be carried out on the doctor blade of the anilox roller 40. The Rot_GDZ, (A)Rot_DZ and (A)Rot_RZ drives run for production in the partial printing unit A. The (A)Posi_Axial drive compensates for lateral register fluctuations, the (A)Rot_DZ drive compensates for longitudinal register fluctuations. In the event of speed changes, the positioning pairs (A)Posi_DZDS/(A)Posi_DZOS and (A)Posi_RZDS and (A)Posi_RZOS move during production, wherein the positioning pairs do not necessarily have to move in parallel.

At a certain point in time, the first job is finished. Now, in order to produce the second print job, the partial printing unit B automatically moves to the printing position to print the second job—specifically with the first printing color of the entire printing system. For this purpose, the drives (preferably servo drives) (B)Rot_DZ and (B)Rot_RZ are set to speed in such a way that this matches the circumference of the flexographic print motif and that this matches the first job in the register (if possible due to identical circumference formats of the two print jobs) or a punch cutter 44 (or a sheet cutter). Once the speed has been reached, the positioning motors (B)Posi_DZDS and (B)Posi_DZOS as well as (B)Posi_RZDS and (B)Posi_RZOS move to the optimum graphic printing position to produce a high-quality flexographic print motif. The data for pressing or print delivery can come from an internal or external data carrier, e.g., from a database. It is also possible to use data from an external scanner that has determined the topography of the flexographic printing plate(s) (printing forme(s)) used.

If necessary, the register sensor system is optionally moved axially by a motor so that the register sensor system moves directly to the location of the print marks, which can be different between two jobs, detects the register marks and controls them longitudinally and laterally (longitudinal and lateral register control). This is timed so that as little waste as possible is produced. The data for the position of the register marks can come from an internal or external data carrier, e.g., a database. However, data for the print mark position can also be used from a scanner, which recognizes the print marks and makes the axial and/or lateral location available to the double printing unit as an XY coordinate, for example. This data can preferably be stored in a cloud or database. As soon as the register mark or register marks are recognized by the sensor, the longitudinal register is controlled via the servo drive (B)Rot_DZ and the lateral register via (B)Posi_Axial.

At virtually the same time, the first job with the corresponding ink is completed in the partial printing unit A and the printing and anilox cylinder is removed from the printing stock or printing cylinder with the positioning drives (A)Posi_RZDS/OS and (A)Posi_DZDS/OS. The printing cylinder (A)Rot_DZ is brought to a standstill so that the printing sleeve can be safely changed in the partial printing unit A in order to immediately prepare for the next job (third job). It may be necessary to change the screen of the anilox roller; (A)Rot_RZ is safely brought to a standstill for this purpose. This is all done while production continues in the partial printing unit B. If it is not necessary to change the screen, e.g., by changing the anilox roller or an anilox sleeve, the (A)Rot_RZ drive continues to run at a preset speed to prevent ink from drying out.

Now the same is done with the second printing unit (of a further double printing unit)—and this is done in the exact path, i.e., the second printing unit carries out these steps in exactly the same way, but at the exact point on the printing stock web where the first printing unit (of a first double printing unit) did so, in order to save waste in this way. If possible, the printing units synchronize themselves in register from the first job to the second job so that no waste is produced in an optional downstream punch cutter (or sheet cutter). It is also possible to switch to a different print format, e.g., from a circumference of 680 mm to 642 mm on the fly. At least two virtual drive axes are used for this purpose, which process two different print formats in the printing press. This enables two different print formats to be printed side by side in the machine at the same time.

Furthermore, the register sensor can be moved axially via a motorized register sensor traverse during the changeover so that the register marks between the first and second job both in the running direction and perpendicular to the running direction. The information on where the register marks are located can come from a scanner that has scanned the position of the register marks on a print sleeve (and preferably from an identification feature, e.g., QR code or RFID chip). This information can be made available in a database or, for example, a cloud. Alternatively, it can also come from a prepress information database (e.g., cloud-based) or as a PDF. The QR code, or another 2D code or the RFID chip, can be scanned or queried as an identification feature and the ID obtained can be used to retrieve associated data, e.g., from a local or cloud-based database, and transfer it to the printing unit for setting.

It is possible that a respective motorized register sensor traverse with corresponding sensor technology or camera is installed in the printing unit for front-side printing and for rear-side printing, which generates the respective information on where the register marks are located, as described in the previous paragraph.

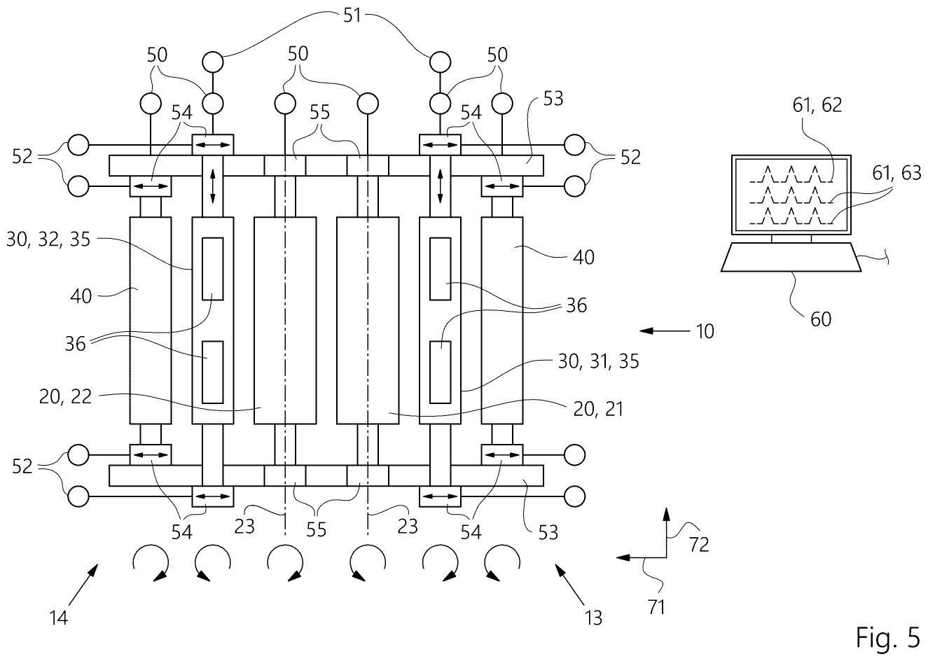

FIG. 5 shows the following: A web-processing flexographic printing machine 1 (also known as a printing installation, system or machine) comprises at least one double printing unit 10 shown with a partial printing unit A or 13, a partial printing unit B or 14 and two impression cylinders GDZ or 20, 21, 22.

A first job is running in the partial printing unit A. At the same time, a second job can be prepared in the partial printing unit B or this printing unit can be serviced in the partial printing unit B, e.g., a blade change on the doctor blade. At a certain point in time, the first job is finished. The partial printing unit B now automatically moves to the printing position to print the second job—specifically with the first printing ink. At virtually the same time, the first job with the corresponding ink is completed in the partial printing unit A.

Now the same is done with the second printing unit (of a further double printing unit)—and this is done in the exact path, i.e., the second printing unit carries out these steps in exactly the same way, but at the exact point on the material path where the first printing unit (of a first double printing unit) did so, in order to save waste in this way. If possible, the printing units synchronize themselves in register from the first job to the second job so that no waste is produced in a downstream punch cutter (or sheet cutter). However, it is also possible to switch to a different print format, wherein the first printing unit is preferably synchronized with the second printing unit in register.

The changeover is event-controlled—on time, on distance, on quantity, on splice, on material change or at the touch of a button. The system is able to process orders simultaneously and process them in sequence.

If at least one intermediate dryer is used in the double printing unit, both partial printing units A and B of a double printing unit can print simultaneously. If a double printing unit with two impression cylinders is used, the production speed can be increased if necessary due to the longer drying distance (between the two impression cylinders). Furthermore, as already described with reference to FIG. 4, it is possible to print two different circumferences in a double printing unit, preferably next to each other. For example, the partial printing unit A can print a circumference of 480 mm onto the web on the DS side (drive side of the machine) and the partial printing unit B can print or prepare a circumference of 960 mm onto the web on the OS side (operating side of the machine). The impression cylinders of the partial printing unit A and/or B can be temperature-controlled, in particular cooled, so that the respective impression cylinder does not expand when heat is generated.

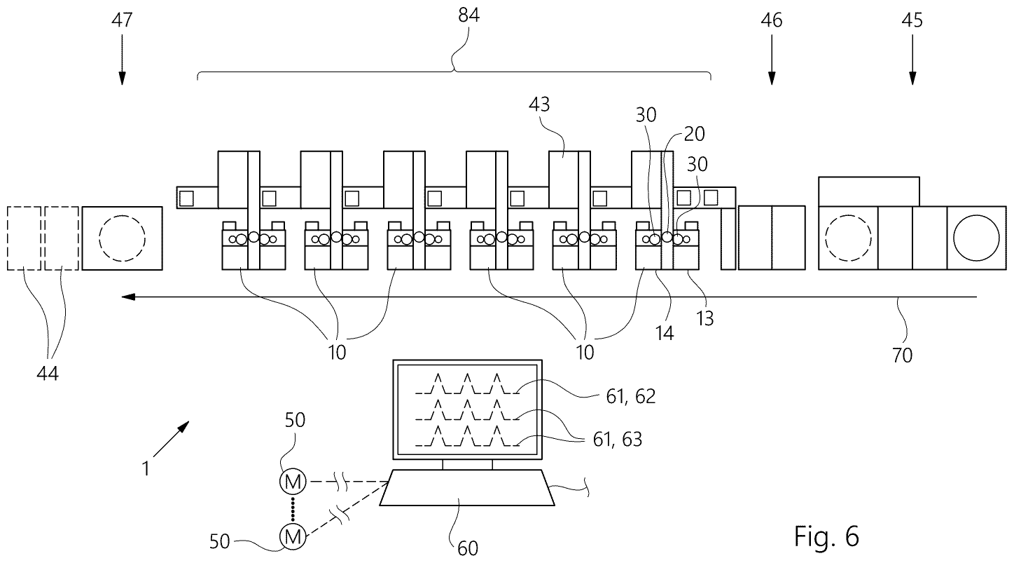

FIG. 6 shows a web-processing, industrial flexographic printing machine 1 with (from right to left or in the production direction 70) a reel changer 45 for the web to be printed, a web feeding device 46, six double printing units 10 with dryers 43 arranged above each printing unit, and a rewinder 47 for the printed and dried web 2. The printing units are arranged in a horizontal row 84. The machine 1 also comprises a computer 60, e.g., a control computer or, simply, a controller. As an alternative to the configuration shown, the production direction 70 can also be reversed (i.e., from left to right in the illustration), wherein the winding units 45 and 47 are interchanged in their function (unwinding and winding).

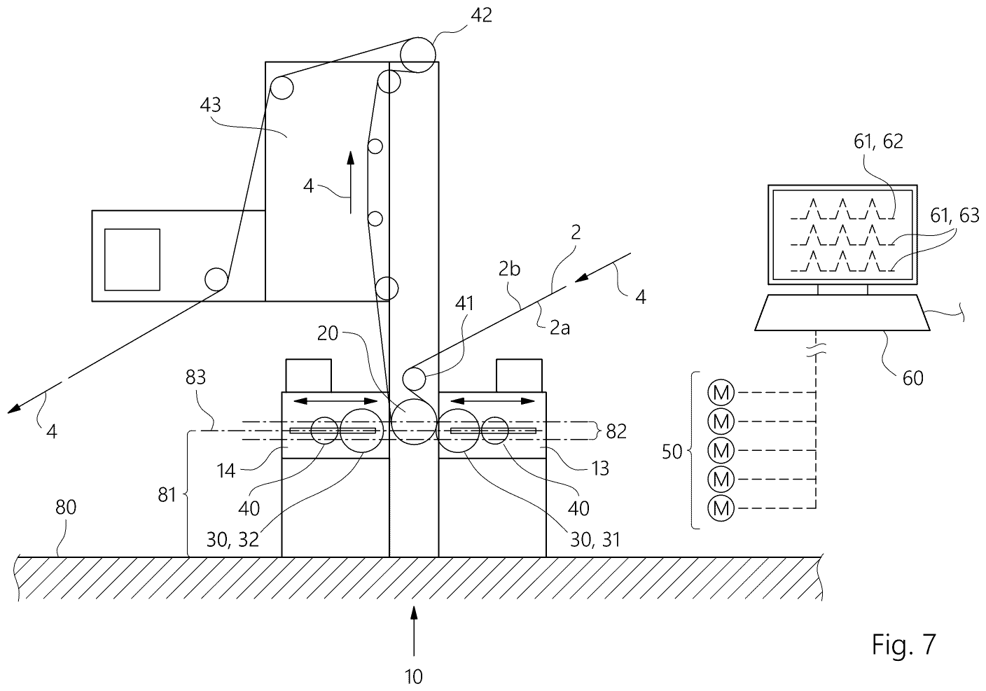

FIG. 7 shows a double printing unit 10 with a single impression cylinder 20 and two partial printing units 13, 14, each with a (flexographic) printing cylinder 30 and an anilox roller 40. The printing cylinders 30 can be disengaged separately from the impression cylinder 20, as can the anilox rollers 40 from the printing cylinders 30. At least one (hot air) dryer 43 is arranged in the superstructure of the double printing unit 10. Such double printing units 10 can be arranged in a horizontal row 84 (cf. FIG. 6). There is also shown in FIG. 7 a horizontal region 82 (in which the rotation axes 23 of the impression cylinders 20 are located) and—more precisely—a horizontal plane 83 (in which the rotation axes 23 of the impression cylinders 20 are located) at an operating height 81 above the floor 80. FIG. 7 also shows five rotary drives 50 (electric motors) for the separately driven cylinders/rollers 20, 30 and 40, which are controlled by the computer 60 using the virtual drive axes 61.

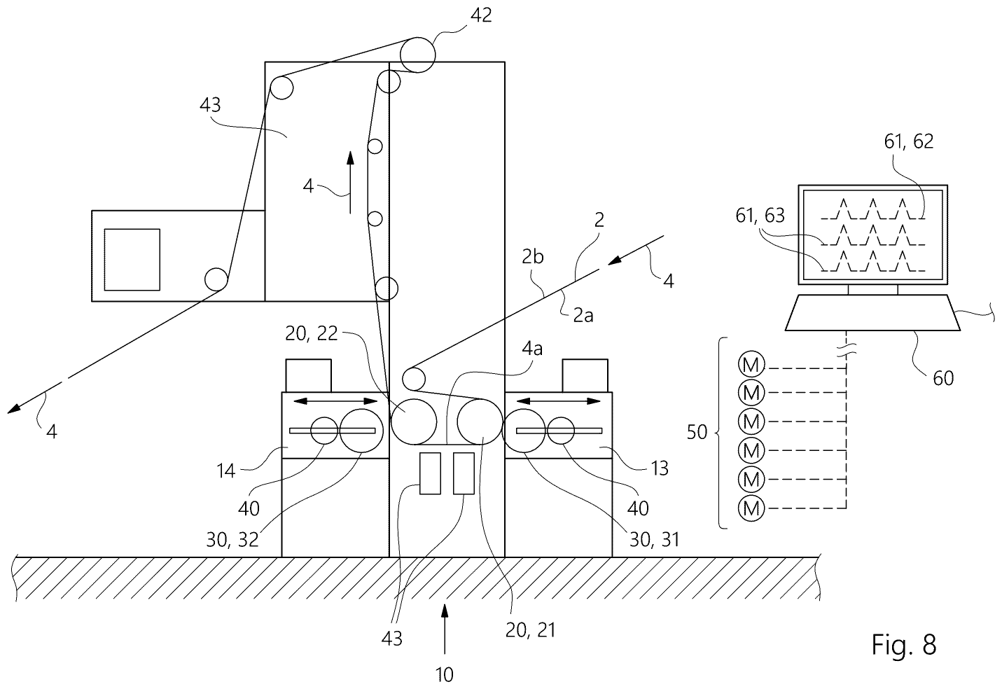

FIG. 8 shows a double printing unit 10 with two impression cylinders 20 and two partial printing units 13, 14, each with a (flexographic) printing cylinder 30 and an anilox roller 40. The printing cylinders 30 can be disengaged separately from the respective impression cylinder 20, as can the anilox rollers 40 from the printing cylinders 30. At least one (hot air) dryer 43 is arranged in the superstructure of the double printing unit 10. Such double printing units 10 can be arranged in a horizontal row 84. FIG. 8 also shows six rotary drives 50 (electric motors) for the separately driven cylinders/rollers 20, 30 and 40, which are controlled by the computer 60 using the virtual drive axes 61. It is also possible to drive the two impression cylinders 20 of the double printing unit 10 using a common drive 50, preferably an electric motor, e.g., by means of transmissions and/or belts.

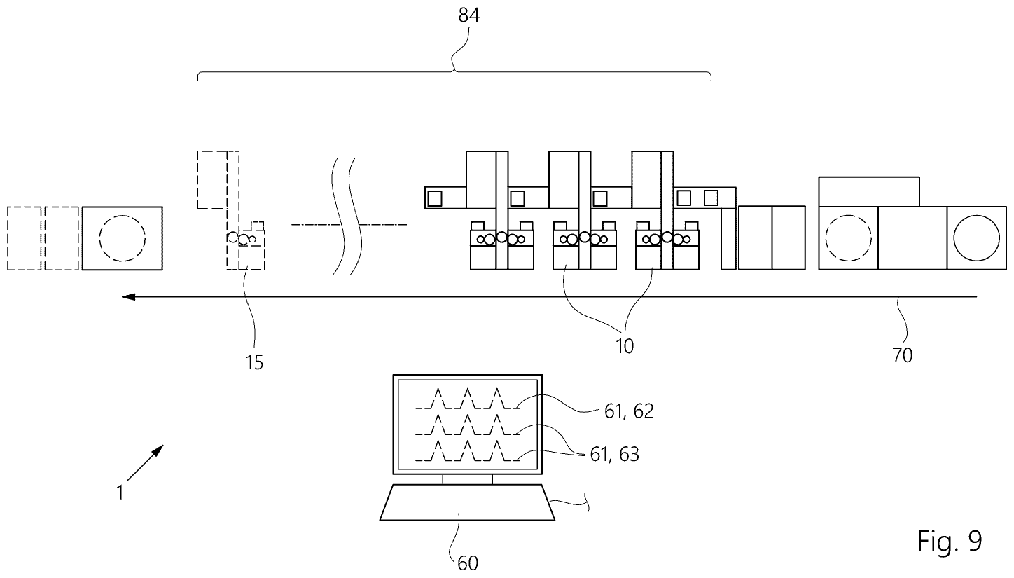

FIG. 9 shows a printing machine 1 similar to FIG. 6, wherein here the printing machine 1 has an additional single printing unit 15, preferably in the production direction 70 after the existing double printing units 10. This single printing unit 15 can be used for a coating application, e.g., as a flexographic printing unit or as a gravure printing unit. Additionally or alternatively, a double gravure printing unit could also be provided.

The following six exemplary operating modes are possible with the illustrated double printing units:

A) Flexographic printing machine for front-side/rear-side printing with selectable web threading path and changeover of the direction of rotation of the rotary cylinder axes. The front and rear sides can be printed in register with each other, but the front and rear sides can also be printed with different print formats. Examples: Front side 490 mm and rear side 980 mm, wherein the colors are printed one inside the other on the front and rear sides. The rear side can be printed and regulated in register or 490 mm and 680 mm printed in register one below the other.

The following axes are changed in the direction of rotation during front to rear-side printing: (A)Rot_RZ, (B)Rot_RZ, (A)Rot_DZ, (B)Rot_DZ, (A)Rot_GDZ at DoD unit, (B)Rot_GDZ at DoD unit, Rot_GDZ at NoD unit, Rot_KUW (rotation drive of the driven chill roller, if present and change of direction of rotation necessary) and Rot_LW (rotation drive of the driven guide roller(s), if present and change of direction of rotation necessary).

B) Register-accurate job changeover between two jobs, wherein the changeover to a punch cutter (rotary punch cutter or flatbed punch cutter or semi-rotary punch cutter or sheet cutter) takes place in register with the same pack size, e.g., 1-liter orange juice pack is changed on the fly to 1-liter grape juice pack, in such a way that this matches the punch cutter or sheet cutter in register. The punch cutter or sheet cutter is preferably at the end of the printing system. Cross-cutting the web by means of the sheet cutter can, when there is a changeover in jobs, advantageously be changed with the correct register and adapted to the new job.

C) Register-accurate job changeover between two jobs, wherein the changeover to a punch cutter (rotary punch cutter or flatbed punch cutter or semi-rotary punch cutter or sheet cutter) takes place with register accuracy for a changing pack size, e.g., 1-liter orange juice packaging is changed on the fly to 0.75-liter grape juice packaging in such a way that the punch cutter introduces the punch cutting tool into the process in the exact register and with the exact length at the time of the changeover or the sheet cutter adjusts its cutting length in the exact register and with the exact length—in such a way that there is minimal waste and the production speed, e.g., 400 m/min, is the same before, during and after the changeover. The punch cutter or sheet cutter is preferably at the end of the printing system.

D) A register sensor controls at least one or both colors of the double printing unit for front-side printing; a register sensor controls at least one or both colors of the double printing unit for rear-side printing.

E) The double printing unit receives print setting data from an external scanner for flexographic printing plates and sets the pressing or print infeed with the drives (A)Posi_DZDS, (B)Posi_DZDS, (A)Posi_RZDS, (B)_Posi_RZOS, (A)Posi_Axial, (B)Posi_Axial.

F) Two different formats can be printed in register. At least two virtual format axes that enable at least two different print formats, i.e., cylinder circumferences, to be printed and prepared in the machine in register or at least two print circumferences to be printed simultaneously and in register next to each other. Example: 680 mm and 480 mm in circumference or e.g., an integer multiple thereof. It is also possible to print several print jobs with different circumferences at the same time, e.g., three or four, i.e., four different pack sizes next to each other.

The following is a summary list of reference numerals and the corresponding structure used in the above description of the invention:
1 printing machine
2 web
2a one side of the web
2b other side of the web
3 longitudinal strips of the web
4 web path
4a web path portion (in the double printing unit between two impression cylinders)
10 double printing unit(s)
11 first double printing unit
12 second double printing unit
13 first partial printing unit
14 second partial printing unit
15 single printing unit
20 impression cylinder
21 first impression cylinder
22 second impression cylinder
23 rotary axes of the impression cylinders
30 printing cylinder
31 first printing cylinder
32 second printing cylinder
33 third printing cylinder
34 fourth printing cylinder
35 sleeve/s
36 printing plate, printing forme
37 first circumferential format
38 second circumferential format
40 anilox rollers
41 web tension roller/s
42 cooling roller/s
43 dryer
44 punch or sheet cutter
45 reel changer
46 web feeding device
47 rewinder
50 drive(s), in particular rotary drive(s)
51 drive(s), in particular positioning drive(s)
52 drive(s), in particular positioning drive(s)
53 side wall
54 adjustable bearing blocks
55 bearing blocks
60 computer
61 virtual drive axis
62 virtual rail transport axis
63 virtual format axis
70 production direction
71 circumferential direction/longitudinal direction
72 transverse direction
73 first direction of rotation
74 second direction of rotation
80 floor of a production facility
81 operating height
82 horizontal region
83 horizontal level
84 horizontal row of printing units, especially double printing units

1. A method for operating a printing machine for flexographic printing, the method comprising:
unwinding a web of printing stock, transporting and guiding the web through at least two double printing units of the printing machine, wherein each of the double printing units includes at least one impression cylinder and two printing cylinders for flexographic printing;
driving each of the impression cylinders in rotation by a separate motor, and driving each of the printing cylinders in rotation by a separate motor; and
calculating by a computer of the printing machine at least two virtual drive axes; and
controlling the motors by the computer in each case using one of the virtual drive axes.

2. The method according to claim 1, which comprises controlling the motors of the impression cylinders using a common virtual web transport axis.

3. The method according to claim 2, which comprises controlling each of the motors of the printing cylinders by using separate virtual format axes, or actuating the motors of the printing cylinders of respective partial printing units of the double printing units by using two virtual format axes, or actuating the motors of the printing cylinders by using a common virtual format axis.

4. The method according to claim 3, which comprises using the common virtual web transport axis with a web angular velocity for controlling the motors.

5. The method according to claim 4, which comprises using the respective virtual format axis with a respective format angular velocity for controlling the respective motors.

6. The method according to claim 5, wherein, when printing a print job, the web angular velocity and at least one of the format angular velocities coincide.

7. The method according to claim 5, wherein, when printing a different print job, the web angular speed and at least one of the format angular speeds differ by a factor not equal to 1.

8. The method according to claim 5, wherein, when printing another print job, the web angular speed and at least one of the format angular speeds differ by a factor of −1.

9. The method according to claim 1, which comprises printing with at least two or all double printing units on mutually opposite sides of the web during a first print job and a second print job.

10. The method according to claim 9, which comprises changing a web path from a first double printing unit to a second double printing unit when switching from the first print job to the second print job.

11. The method according to claim 10, wherein the web path during the first print job lies substantially over a horizontal region in which the axes of rotation of the impression cylinders are located.

12. The method according to claim 11, wherein the web path during the second print job lies partially below the horizontal region in which the axes of rotation of the impression cylinders are located.

13. The method according to claim 1, which comprises in a first print job, actuating a first printing cylinder of a first double printing unit and a third printing cylinder of a second double printing unit using a same virtual format axes, or, in the first print job, actuating the first printing cylinder of the first double printing unit and a fourth printing cylinder of the second double printing unit using the same virtual format axes.

14. The method according to claim 13, which comprises during a second print job, actuating a second printing cylinder of the first double printing unit and a fourth printing cylinder of the second double printing unit using the same virtual format axes, or, during the second print job, actuating a second printing cylinder of the first double printing unit and a third printing cylinder of the second double printing unit using the same virtual format axes.

15. The method according to claim 14, which comprises controlling the printing cylinders using different virtual format axes in the first print job and in the second print job.

16. The method according to claim 1, which comprises printing the web on at least one side in at least two mutually parallel longitudinal strips.

17. The method according to claim 16, which comprises printing print jobs with different formats in the longitudinal strips.

18. The method according to claim 1, which comprises providing at least one dryer for operating on the web path in each double printing unit between two impression cylinders, and drying the web in each double printing unit.

19. The method according to claim 1, which comprises arranging and operating the double printing units in a horizontal row.

20. The method according to claim 19, wherein the double printing units are arranged with axes of rotation of the impression cylinders lying in a horizontal region.

21. The method according to claim 1, which comprises effecting a flying change between a first print job and a directly following second print job.

22. The method according to claim 21, which comprises operating at least two double printing units and making a switchover from one partial printing unit to another partial printing unit or vice versa.

23. The method according to claim 22, which comprises effecting the switchover in register.

24. The method according to claim 22, which comprises carrying out the switchover precisely along a path.

25. The method according to claim 22, which comprises changing a format.

26. The method according to claim 22, which comprises changing at least one printing ink.

27. The method according to claim 1, which comprises using the computer to calculate a first virtual drive axis for the motors of mating printing cylinders of the double printing units, using the computer to calculate a second virtual drive axis for motors of format cylinders of first partial printing units of the double printing units for a first print job and a third virtual drive axis for motors of format cylinders of second partial printing units of the double printing units for a directly following second print job, and performing a flying changeover from the first print job to the second print job, changing from the second virtual drive axis to the third virtual drive axis.
